(19) United States
(12) Patent Application Publication
(10) Pub. No.: US 2018/0011185 A1
(43) Pub. Date: Jan. 11, 2018

(54) METHOD AND SYSTEM FOR LOCATING UNDERGROUND TARGETS

(71) Applicant: Dov ZAHAVI, Raanana (IL)

(72) Inventors: Dov ZAHAVI, Raanana (IL); Gregory ZLOTNICK, Haifa (IL); Aharon LEVI, Kiryat Bialik (IL); Avi MEIDAN, Cesarea (IL)

(21) Appl. No.: 15/710,500

(22) Filed: Sep. 20, 2017

Related U.S. Application Data
(63) Continuation of application No. PCT/IL2016/050383, filed on Apr. 12, 2016.

(30) Foreign Application Priority Data
Apr. 12, 2015 (IL) 238208

(51) Int. Cl. G01S 13/87; G01S 13/88

(52) U.S. Cl. CPC G01S 13/878; G01S 13/887

(57) ABSTRACT

A method and a system for locating underground targets by using radar signals emitted from a radar transmitter coupled to a transmitter antenna, and echoed signals collected from a target by a radar receiver coupled to a transmitter antenna. The radar signals are collected via the receiver antenna which translates above ground along a closed course in cooperation with the transmitter antenna. The radar signals are processed in correlation with time and with a respective momentaneous location of the receiver antenna and the location of the transmitter antenna. The transmitter antenna is disposed on a land borne platform and the receiver antenna is disposed on the same land borne platform or on another land borne platform or on an airborne platform. The land borne platform and the airborne platform are selected as a mobile platform, a driver guided platform, a remotely guided platform, or an autonomously guided platform.

This application is a Continuation application of International Patent Application No. PCT/IL2016/050383, filed Apr. 12, 2016, which claims priority from Israeli Patent Application No. 238208, filed Apr. 12, 2015, the entire disclosures of both of which are incorporated by reference herein.

### TECHNICAL FIELD

The embodiments described hereinbelow relate to the detection of underground targets such as large objects and structures, and in particular, to the detection of underground tunnels for the smuggling goods and for illegal passage of immigrants across borders.

### SUMMARY OF INVENTION

It is an object of the embodiments of the present invention to provide a method and a system for locating a target disposed below ground. Use is made of radar signals including emitted signals generated by a radar transmitter and echoed signals collected from a target by a radar receiver which is coupled to at least one receiver antenna. This includes transmitting emitted radar signals, collecting radar signals, and processing the radar signals. The emitted signals are transmitted via a transmitter antenna which is coupled to the radar transmitter and is disposed at a predetermined location relative to the ground. The echoed radar signals are collected via the at least one receiver antenna which translates above ground along a controlled closed course selected for operation in cooperation and in association with the transmitter antenna. The radar signals are processed in correlation with a respective momentaneous location of the at least one receiver antenna and the predetermined location of the transmitter antenna.

Accordingly, in view of the embodiments of the present claimed invention, the transmitter antenna may be disposed in the top soil of the ground, in contact with the ground, and up to 10 meters above the ground.

Furthermore, but still in view of the embodiments of the present claimed invention, the emitted signals may be collected along at least 50%, 75%, or 90% of the controlled closed course. Moreover, the emitted signals may be selected as video pulse strings having a succession of one positive pulse and one negative pulse, and may have an emission frequency ranging from 10 Megahertz to 100 Megahertz.

In accordance with the embodiments of the present claimed invention, intervals separating apart between a time of transmission of an emitted signal and a time of reception of a respective echoed signal are collected along and over the closed course as time delays from which a maximum time delay and a minimum time delay are derived. Each time delay is correlated with a momentaneous location on the course of the at least one receiver antenna at time of collecting signals, and a vector on the course ranging from the location of the maximum time delay to the location of the minimum time delay points in a direction of the target.

Moreover, according to the embodiments of the present claimed invention, the transmitter antenna may be disposed on a land borne platform and the at least one receiver antenna may disposed on the same land borne platform or on a platform selected as at least one of another land borne platform or an airborne platform. Land borne platform(s) and airborne platform(s) may be selected as at least one of a mobile platform, a driver guided platform, a remotely guided platform, and an autonomously guided platform.

It is a further object of the embodiments of the present invention to provide a transmitter antenna that is selected as a dipole antenna, a conic antenna, or a whip antenna.

Another object of the present claimed invention is to provide The shape of the closed course may be selected as one of a circle, an ellipse, a symmetric shape, and an asymmetric shape.

It is another object of the present claimed invention to provide a system control and data processing unit including a non-transitory processor readable medium for storing instructions therein that, when executed by a processor, will cause system to operate any one out of the method steps.

Still another object of the present claimed invention is to provide a method for scanning an initial site of ground for detecting and for locating a target buried underground by providing a radar transmitter coupled to a transmitter antenna, and at least one receiver antenna coupled to a radar receiver. The method may comprise the following steps. First, disposing the transmitter antenna at a known location relative to the ground, and emitting radar signals generated by the radar transmitter. Second, operating at least one receiver antenna translating on a closed course on or above ground and in range for operative association with the transmitter antenna for collecting radar signals received from a plurality of separated apart known locations of the at least one receiver antenna. Third, processing the collected signals for detecting a target, wherein when the target is not detected, relocating the transmitter antenna and the at least one receiver antenna to a next site and repeating steps a)-c) until the target is detected. When the target is detected, processing the collected signals for deriving a first location of the target and indicating the site as a first site.

It is yet another object of the present claimed invention to provide a method and a system for deriving a second location of the target, repeating steps a)-c) at a next site distanced away relative to the first site, until the target is detected. Once the target is detected at the next site, the collected signals, which are those of the second location of the target, are processed and indicate the next site as a second site. Evidently, the orientation of the target may be derived from the first location and from the second location of the target.

In accordance with the embodiments of the present invention, each one of the transmitter antenna and of the at least one receiver antenna(s) may be disposed on a separate mobile platform, and the at least one receiver antenna(s) and the transmitter antenna operate in mutual association. The transmitter antenna may be disposed on a land borne platform and the at least one receiver antenna is disposed on one of a land borne platform and an airborne platform.

It is a further object of the embodiments of the present invention to provide a system configured to operate a range only radar to scan sites of ground in search of a location of a target disposed under the ground. The range only radar has a radar transmitter that is coupled to an emitter antenna which transmits emitted signals to a radar receiver which collects radar signals including the emitted signals and echoed signals returned from the target. The system is commanded and controlled by a system control and data processing unit SCDP which may comprise:

at least one receiver antenna which is coupled to the radar receiver and is configured to collect the radar signals from the emitter antenna TA that is disposed at a predetermined location relative to the ground,

wherein the at least one receiver antenna RA is configured to translate along a closed course CRS that is operative in association with the emitter antenna TA,

wherein a momentaneous location of the at least one receiver antenna RA is monitored, and wherein the momentaneous locations and the collected radar signals are saved as signals correlated with time, and wherein the location of the emitter antenna. TA and the time correlated signals are processed by the system control and data processing unit SCDP.

However, one more object of the embodiments of the present invention is to provide a system wherein emitted signals and target returned echoed signals are collected by the at least one receiver antenna RA from a plurality of distributed apart locations that are disposed on the closed course are used to derive location coordinates of the target.

Yet one more object of the embodiments of the present invention is to provide a system wherein the system control and data processing unit SCDP is configured to control a rate of pulses of emitted signals and a speed of translation of the least one receiver antenna RA for mutual adaption of the rate of pulses and of the speed of translation. The system control and data processing unit SCDP may be configured as a centralized or as a distributed unit that is operable to control and command the system. In addition, the least one receiver antenna RA and the emitter antenna TA may be disposed on a same platform or on different platforms, and may operate in mutual association.

Accordingly, the system control and data processing unit SCDP may derive data indicative of an underground speed of propagation of a wave of radar signals from a delay of time that separates apart between a time of transmission from the emitter antenna TA of one emitted signal, and a time of collection by the at least one receiver antenna RA of a respective one echoed signal. The at least one receiver antenna RA may translate along a closed course CRS, which closed course is relative to the emitter antenna TA that collects radar signals at a predetermined angular separation of least at five degrees on the closed course.

### Technical Problem

The problem of detecting border-crossing underground tunnels is well known per se. Examples thereof are tunnels between Mexico and the United States, and tunnels between North and South Korea.

### Solution to Problem

To solve the problem, use is may be made of a range only radar, for example a bistatic range only radar which has by definition, a transmitter unit separated apart from a receiver unit. The transmitter unit, which is disposed relative to the ground level, and the receiver unit, both operate in mutual association. Radar signals emitted by the transmitter unit are collected as collected signals by at least one receiver antenna which is disposed either at a plurality of locations relative to the transmitter unit, or loops above ground relative to the transmitter unit. Collected signals include both emitted signals and signals echoed from a target. A central processing unit then collects emitted and echoed signals, to compute time delays therebetween and to derive an azimuth to the target, a location of the target when detected relative to the transmitter unit, and the orientation of the target.

A simplified schematic illustration of the method and the system for the detection of underground targets in idealized conditions is depicted in FIG. 1.

FIG. 1 shows a radar transmitter TX coupled to a transmitter antenna TA which is disposed on the ground G, and a radar receiver RX which may be coupled to a receiver antenna RA that is disposed above ground AG. The transmitter antenna TA emits signals that radiate spherically as a hemisphere above ground AG into the air, and as a hemisphere underground UG into the soil S. For the sake of clarity of FIG. 1 hemispheres are not shown, and only one emitted signal is shown as a full line arrow, above ground AG and underground UG. The above ground emitted portion 12AG of the emitted signals 12 are received by the receiver antenna RA while the portion of the underground propagating signals 14. The signals 12 have an above ground portion 12AG and an underground portion 12UG, and likewise, the signals 14 have an above ground portion 14AG and an underground portion 14UG The underground target TRGT, which is an obstacle to the emitted signals, may include for example a long piece of pipe, a large structure or an underground tunnel.

For the sake of simplicity of illustration, only one reflected signal 14 respective to the emitted signals 12 is shown in FIG. 1 as a straight dashed line that passes through the shortest geometric distance separating the target TRGT part from the receiver antenna RA. It is assumed that both of the underground UG and the above ground AG media are isotropic and allow the propagation of emitted signals 12 and of reflected signals 14 at the same speed. Moreover, it is further assumed that the ground level GL is more or less planar and that refraction does not occur at ground level GL which is the interface separating between the underground UG medium from the above ground AG medium. Refraction is a well-known phenomenon and will be discussed hereinbelow. Evidently, the underground portion 12UG of the emitted signal 12 and the underground portion 14UG of the reflected signal 14 travel at a lower velocity than the above ground portions 12AG and 14AG. It is well known that electromagnetic signals propagate slower in the soil S of the underground UG than in the air.

The location of the transmitter antenna TA and of the receiver antenna RA is known and thus also the distance separating therebetween.

The reception of a reflected signal 14 is indicative of the detection of an underground obstacle or target TRGT, but the distance separating apart between the transmitter antenna TA and the obstacle or target TRGT is unknown. However the speed of propagation of electromagnetic signals in the soil S of the underground UG may either be known a priori, or be measured on site by use of a reference target which is disposed at a known distance from the transmitter antenna TA and the receiver antenna RA. Alternatively, the speed of propagation of electromagnetic signals in the soil S may be derived in laboratory from samplings taken from the underground soil S or estimated by analyzing the delay changes due to the changes of location of the receiver antenna RA.

Finding the location of the target TRGT is considered with respect to FIGS. 2, 3 and 4, to which apply the same assumptions and limitations as described with relation to FIG. 1. For the sake of clarity a point target is assumed.

It is well known that according to the fixed difference geometric property of hyperbolas, ships at sea are able to determine their own location based on the difference of time at which signals are received from say, two beacons that are disposed at known and fixed positions. Advantage is taken from the same geometric property of hyperbolas, here in a three dimensional ground volume, to find the location of an underground target TRGT. Ellipses may also be used for the same purpose.

FIG. 2 shows the same transmitter antenna TA and target TRGT as in FIG. 1, but with two receiver antennas RA, namely RA1 and RA2. The two antennas RA1 and RA2 are disposed in the same plane PL above ground AG and are equidistant from the transmitter antenna TA. A configuration with three receiver antennas wherein the marking of the radar signals is described is shown in FIG. 3.

FIG. 3 is a top elevation of FIG. 2 and shows an imaginary closed circular course CRS disposed above ground AG in the plane PL, at an angular separation of 120° for example. For ease of illustration, the transmitter antenna TA is disposed at the center of the circular course CRS. It is noted however, that the transmitter antenna TA is preferably but not necessarily disposed at the center of the course CRS, and may even be disposed outside of the closed course CRS. In other words, the course CRS does not have to concentrically circumscribe the transmitter antenna TA. Alternatively, instead of three receiver antennas, one may consider one receiver antenna RA that is translated into various locations over the closed course CRS.

In FIG. 3, signals emitted by the transmitter antenna TA are received by a receiver antenna RA first directly when emitted and second, after a time delay Δt, as echoed signals that are reflected from a target TRGT. The signals depicted in FIG. 3, are marked as follows. A radar signal 12AG, emitted by the transmitter antenna TA at time t0 and received by the antenna RA1 after a lapse of time t1, is suffixed with an index “1” as t11, since related to the first antenna RA1. The to the underground emitted signal 12UG, that hits the target TRGT at time t2 after time t0, is marked as t21, and is reflected therefrom to the receiver antenna RA1 after a further delay, is marked t31. An emitted signal 12AG is thus received at the receiver antenna RA1 at time t11, and, the reflected signal 14 reaches the receiver antenna RA1 at time t21+t31.

Markings similar to those used for the receiver antenna RA1 but with the suffixed index “2” are indicated with respect to the receiver antenna RA2. An emitted signal 12AG is received at the receiver antenna RA2 at time t12, and the reflected signal 14 reaches the receiver antenna RA2 at time t22+t32. The same similar markings are used with respect to the antenna RA3 with the suffix “3”.

The first step to derive the location of the target TRGT is to calculate the absolute value of the difference of time lapsing between the reception of the signal (t21+t31) collected by the receiver antenna RA1 and the reception of the signal (t22−t32) which is collected by the receiver antenna RA2. The result thereof is saved as the time difference or time delay Δ12. The second step is to calculate the absolute value of the difference of time lapsing between the signals (t22+t32) and (t23+t33), relative respectively to the receiver antennas RA2 and RA3, as the time difference or time delay Δ23. The same is repeated for the receiver antennas RA3 and RA1, with the signals (t23+t33) and (t21+t31) to obtain the time difference or time delay Δ31. It is noted that t21=t22=t23 because the distance from the emitter antenna TA to the target TRGT is irrespective of the position of the receiver antennas RA. The three time difference values Δ12, Δ23, and Δ31 now allow the derivation of three hyperbolas on the basis of the known location of the transmitter antenna TA and of the receiver antennas RA1, RA2, and R3 as well as their known separation distance.

When the plane PL is not parallel to the ground G, it suffices to rotate the system of coordinates to obtain results according to the same process as described hereinabove. The three receiver antennas RA1, RA2, and RA3, may be substituted by a translatable receiver antenna RA that translates from one location to another location.

FIG. 4 depicts a singular configuration where the receiver antennas RA1, RA2, and R3 are disposed above ground AG in the same plane PL, which is parallel to the ground G. The three receiver antennas RA, RA2, and R3 are further disposed on a circular closed course CRS that is centered about the transmitter antenna TA, and are separated apart by an angle of about 120° to form the apexes of an equilateral triangle. The time of flight TOF of the emitted signals 12 and of the reflected signals 14 is indicated as tij, where both i and j are positive integers: i is related to the signals, thus 1, 2, or 3, . . . n, and j refers to the identifier of the specific receiver antenna RA, thus for example 1, 2, or 3, . . . m.

FIG. 5 schematically shows three successive positions, indicated as RA1, RA2, and RA3, through which a receiver antenna RA is translated, or else, the position of three different antennas RA1, RA2, and RA3. For the sake of illustration, FIG. 5 further schematically depicts three branches of hyperbolas, namely H1, H2, and H3, and their respective point of intersection O that provides coordinates of the target TRGT

The calculations necessary for finding the intersection O of the hyperbolas may be found at en.wikipedia.org/wiki/Multilateration.

There has thus been described an example in principle, of a method that uses a range only radar to detect a target TRGT and derive a location thereof at a first site, in a three dimensional underground volume of soil S.

Still unknown is the orientation of the target TRGT which may have a longitudinal dimension such as may be the case for example with a slender and oblong container, a pipe, or an underground tunnel. The remedy thereto is to reposition the stationary transmitter antenna TA to a different second site, away relative to the previous first site, and to repeat the target locating procedure. Thereby, there is obtained at the second site, or second location, a second crossing point O of the hyperbolas on the target TRGT. The segment of a line passing through the two derived locations, i.e. at the first site and the second site, indicates the orientation of the tunnel.

### Advantageous Effects of invention

Embodiments of the method and implementation of the system described hereinbelow achieve manual, semi-automatic, automatic, and even autonomous operation dedicated to the detection of the location of underground targets TRGT and of their orientation.

Automatic and autonomous systems for repetitive tasks are advantageous per se. Furthermore, the hardware involved with the implementation is practically available off the shelf.

### BRIEF DESCRIPTION OF DRAWINGS

Non-limiting embodiments of the invention will be described with reference to the following description of exemplary embodiments, in conjunction with the figures. The figures are generally not shown to scale and any measurements are only meant to be exemplary and not necessarily limiting. In the figures, identical structures, elements, or parts that appear in more than one figure are preferably labeled with a same or similar number in all the figures in which they appear, in which:

FIGS. 1 to 5 illustrates nomenclature and principles of operation of a range only radar system for detecting underground targets,

FIG. 6 is an exemplary block diagram of a system depicted in FIGS. 1 to 5,

FIG. 7 shows a block diagram of the main elements of the radar transmitter TX and of the radar receiver RX,

FIG. 8 depicts an exemplary video pulse emission signal,

FIG. 9 illustrates a cross section taken perpendicular the ground G and through of the transmitter antenna TA,

FIG. 10 schematically depicts an exemplary embodiment of the method and of the system 100 which operates a set of platforms PLTF on a volume of ground VG at a site ‘a’,

FIG. 11 is a schematic illustration of the time delays Δt derived along a loop of a mobile receiver antenna RA that translates on a closed course CRS,

FIG. 12 shows a flowchart for the sake of illustration of a simplified example of the operation of the system 100, and

FIG. 13 depicts a platform carrying a transmitter antenna and a receiver antenna,

### DESCRIPTION OF EMBODIMENTS

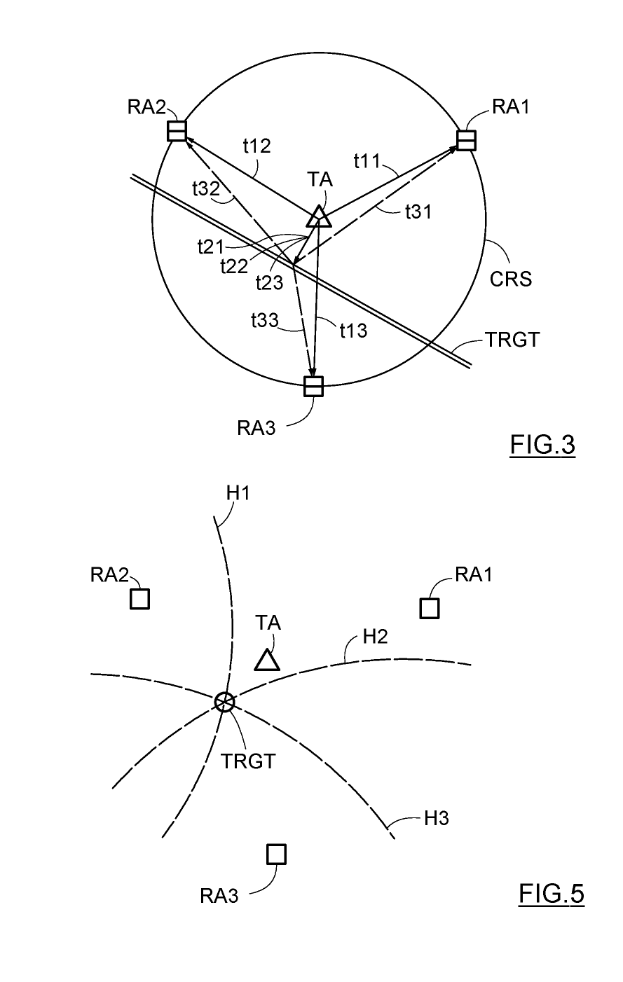

FIG. 6 depicts a schematic block diagram of an exemplary embodiment 1000 of a system 100 operating the method for detecting, locating, and finding the orientation of an underground target TRGT. FIG. 6 shows the links coupling between an operation station OS, a system control and data processing unit SCDP, a radar transmitter TX with an emitter antenna TA, and a radar receiver RX with a receiver antennas RA.

Under command of the operation station OS, the system control and data processing unit SCDP operates possibly in bidirectional communication with the radar transmitter TX, which generates signals that are emitted by the emitter antenna TA. Elements marked with the prefix ‘a’ indicate that they are disposed at a site ‘a’. The emitter antenna TA marked as aTA is thus disposed at the site ‘a’. The emitter antenna TA sends emitted signals 12 directly to the receiver antenna(s) RA and through the ground G, to the target TRGT wherefrom they are returned as echoed signals to the receiver antenna(s) RA. The radar receiver RX is coupled in bidirectional communication to the system control and data processing unit SCDP which accepts the radar signals, for storage in memory, analysis, processing and output of data. The operation station OS is coupled in bidirectional communication to the system control and data processing unit SCDP, which for example receives commands therefrom and forwards data thereto.

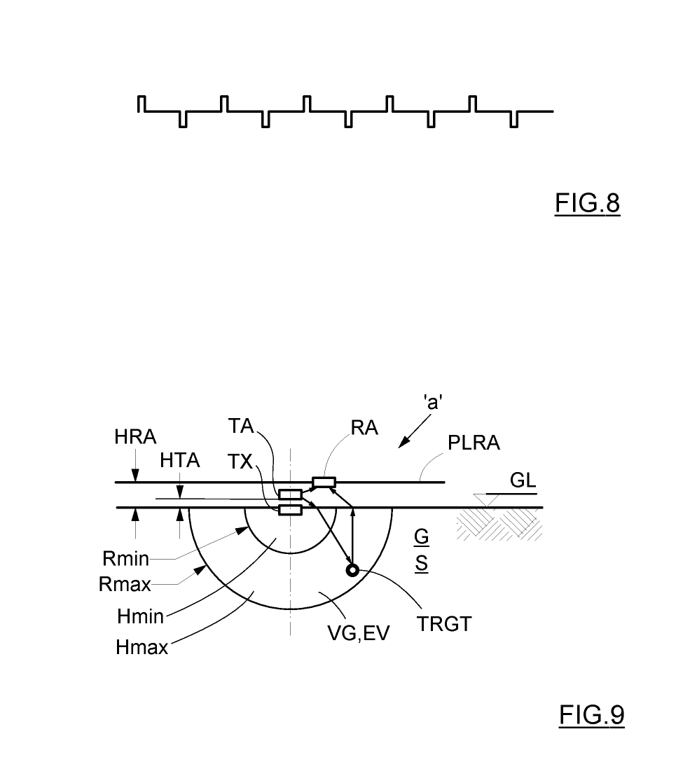

A bidirectional transmitter communication channel TACC, shown as a dashed line with a double headed arrow, may link the system control and data processing unit SCDP to the emitter antenna TA. The system control and data processing unit SCDP may for example, direct commands via the transmitter communication channel TACC to a platform PLTF, shown in FIG. 10, which may support a radar transmitter TX and an emitter antenna TA, to dispose the emitter antenna TA at a specific location, and/or to control parameters of the emitted signals, such as signal power, pulse width, and frequency. In parallel, the system control and data processing unit SCDP may monitor and gain data about the exact momentary spatial location of the emitter antenna TA, via the transmitter communication channel TACC.

A bidirectional receiver communication channel RACC, shown as a dashed line with a double headed arrow, may couple the system control and data processing unit SCDP with the radar receiver RX and the receiver antenna(s) RA. The system control and data processing unit SCDP may for example, direct commands via the receiver communication channel RACC to at least one platform PLTF, shown in FIG. 10 to dispose the receiver antenna(s) RA at a specific spatial location. In parallel, the system control and data processing unit SCDP may monitor and derive time correlated location data of the receiver antenna(s) RA via the receiver communication channel RACC. Signals collected by the receiver antenna RA may be sent to the system control and data processing unit SCDP unit via the receiver communication channel RACC.

In summary, the system control and data processing unit SCDP may perform the following tasks with respect to the subsystems and elements of the system 100:

Operation, monitoring and command of the subsystems and elements thereof,

Determination of the mode of operation of the subsystems, including pulse width, transmission power, frequency, pulse rate, course CRS of the receiver antenna(s) RA and their speed of translation,

Management of communications between the subsystems and elements thereof,

Control of the location of the receiver antenna(s) RA relative to the transmission antenna TA,

Sampling of the emitted signals 12 and of the collected signals 14, for example at a resolution of 1 nanosecond and a dynamic range of up to some 100 dB and more, and their storage in memory. A sampling rate of 100 MHz may suffice for pulses having a central frequency of up to 20 MHz, and for pulses having a central frequency of up to 40 MHz, a sampling rate of 250 MHz may suffice, and

Processing of the collected signals, includes derivation of the azimuth towards the target TRGT, the location of the target, and the orientation of the target.

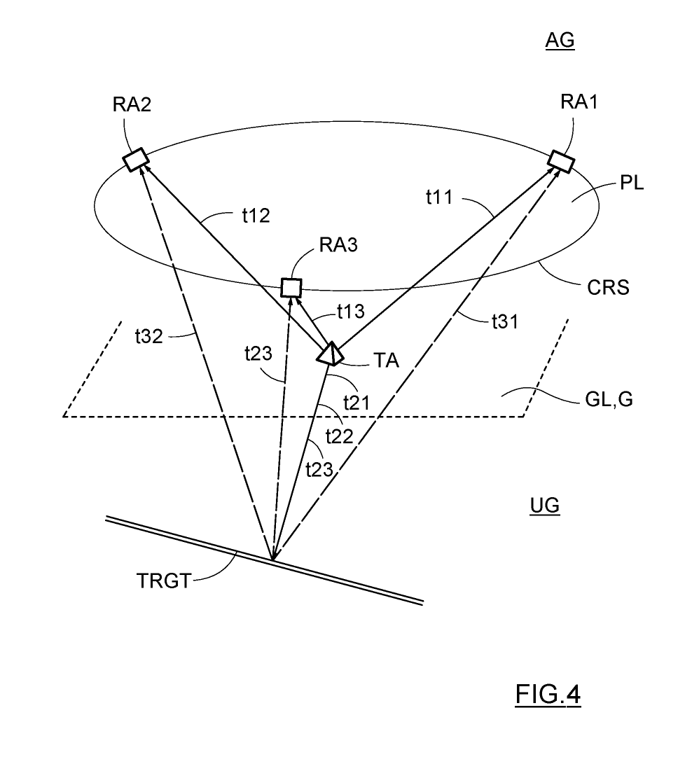

When the radar receiver RX does not include a repeater unit 46, shown in FIG. 7, the double headed arrow RACC may become a single-headed arrow pointing towards and providing a link to the system control and data processing unit SCDP.

Knowledge of the relative location or of the coordinates of the location of the transmitter antenna TA and of the receiver antenna(s) RA, in time correlation with the emitted signals and the collected signals, is a prerequisite condition for the operation of the system 100 and for the implementation of the method described herewith.

### Platforms

For a stationary implementation of the system 100, the transmitter antenna TA and a plurality of receiver antennas RA may be immobile. The transmitter antenna TA may be disposed relative to the ground G, for example in the topsoil, on the ground G, or above the ground G. The receiver antennas RA may be disposed at fixed known locations, say for example on top of spaced apart poles or booms. However, the receiver antennas RA need to be disposed in appropriate range for operative association with respect to the transmitter antenna TA.

In dynamic implementations of the system 100, the transmitter antenna TA and the receiver antenna(s) RA may be disposed on displaceable and mobile platforms PLTF, and may operate either at standstill or when in movement. With dynamic systems, when the transmitter antenna TA is operative, the transmitting platform PLTF may be actually stationary, or may be regarded as being practically stationary in appropriate relative conditions, and may be disposed relative to the ground G, i.e. in the topsoil, on the ground G, or above ground G.

The receiver antenna(s) RA that are disposed on mobile platforms PLTF, may evidently operate at standstill but may also operate in such a translation that may be accepted as being practically a standstill. As previously described, the system control and data processing unit SCDP, or another unit of the system 100, may control and monitor the receiver antenna(s) RA. Such control may include the selection of the speed of translation of the receiver antenna RA, as well as the selection of the location of the site ‘a’, and of the shape of the closed course CRS. According to command, the transmitter antenna TA may emit about 1,000,000 pulses/sec at a frequency of 50 MHz, for a wave length of 6 m, and the speed of translation of a receiver antenna RA may be selected as 1 m/sec. This means that during the integration of 1,000 pulses the receiver antenna RA will travel over a distance of 1 cm, which is negligible and may be regarded as if the receiver antenna RA is stationary. Hence a valuable coherent integration may be obtained, from which desired location coordinates may be derived at a precision level of a few centimeters. Even though a translating receiver antenna RA is referred to, a plurality of receiver antennas RA that are stationary when in operation at a site ‘a’ may also be practical.

In, on, or above the ground G, or near the ground G, means that the transmitter antenna TA may be disposed in a range that spans from a disposition in the top soil and up to about a few meters above the ground, say up to 10 meters. This operative association in, on, or above the ground G may also be selected for stationary implementations of the system 100. With a dynamic system 100, the receiver antenna(s) RA may translate along a closed course CRS through at least one or more loops. The course CRS is selected to maintain the receiver antenna(s) RA in range for operative association with the transmitter antenna TA. It is noted that the emitted and collected signals, i.e. the radar signals, are timed and correlated with the instantaneous spatial coordinates of the transmitter antenna TA and of the receiver antenna(s) RA, and are saved in memory.

Mobile platforms PLTF may be piloted vehicles such as land going, airborne, manually or remotely controlled, automatic vehicles either preprogrammed or autonomously guided, with which are well known and with which those skilled in the art are well acquainted. The instantaneous or momentary location of such mobile vehicles may be accurately monitored and they may be driven to and conducted for disposition at predetermined locations at selected instants in time. Alternatively, land borne and airborne mobile platforms PLTF may be monitored and precisely report the time and the location at which radar signals have been emitted and have been collected. Mobile platforms PLTF may translate along selected closed trajectories and courses of travel CRS, on the ground G and/or above the ground G, as best suited for the desired operation(s). One or more platforms PLTF supporting, respectively, one or more receiver antennas RA may translate in a circle, an ellipse or another closed geometric shape that ensures appropriate range for operative association between the transmitter antenna TA and the receiver antenna(s) RA. Such closed course CRS shape is considered as appropriate as long as a significant range deviation of the collected signals presents a difference of several range resolution units, for the points sampled from the volume of ground VG of interest along a loop over the closed course CRS. A volume of interest is the effective volume VE or the volume of ground VG at a site ‘a’ that is scanned by the radar system 100, as detailed hereinbelow.

An exception is noted for a singular configuration wherein a circular course CRS is centered above the transmitter antenna TA which is disposed just above the target TRGT and will therefore provide time delays Δt having the same duration. Such a singular configuration is described hereinbelow, to which configuration an elliptical course CRS is a remedy.

Receiver antennas RA may be supported on land borne or airborne platforms PLTF such as lighter than air, fixed wing, or rotorcraft platforms, including for example, airplanes, helicopters, or drones such as winged drones or quadcopters.

Airborne receiver antennas RA collect emitted and echoed signals which are defined as radar signals. The radar signals may be collected at different predetermined locations and ranges respective to the emitter antenna TA. The locations and ranges at which the radar signals are collected may be transmitted and saved. A platform PLTF that supports receiving antenna(s) RA may loop in a selected closed course CRS in range for operative association with the emitter antenna TA and sample radar signals, which samples are identified, stored, and saved in correlation with time and with the location of the platforms PLTF. More than one loop over the closed course of travel CRS, to collect additional data, may enhance the reliability and accuracy of the results that are derived from the collected data.

The radar transmitter TX may advantageously be supported on a mobile platform PLTF, such as a land going platform+, say a vehicle such as a truck, or a truck tractor and semitrailer, to facilitate transfer thereof from one site to another. An extended range ground-penetrating radar signal may require a powerful radar transmitter TX that is heavy and voluminous. At a selected site ‘a’, the truck may stop and dispose the radar transmitter TX and/or the transmitter antenna TA in appropriate orientation and attitude relative to the ground G prior to operation.

One may also consider support of the radar transmitter TX on an airborne platform PLTF, such as a helicopter, a quadcopter, or an aerostat, dirigible or not.

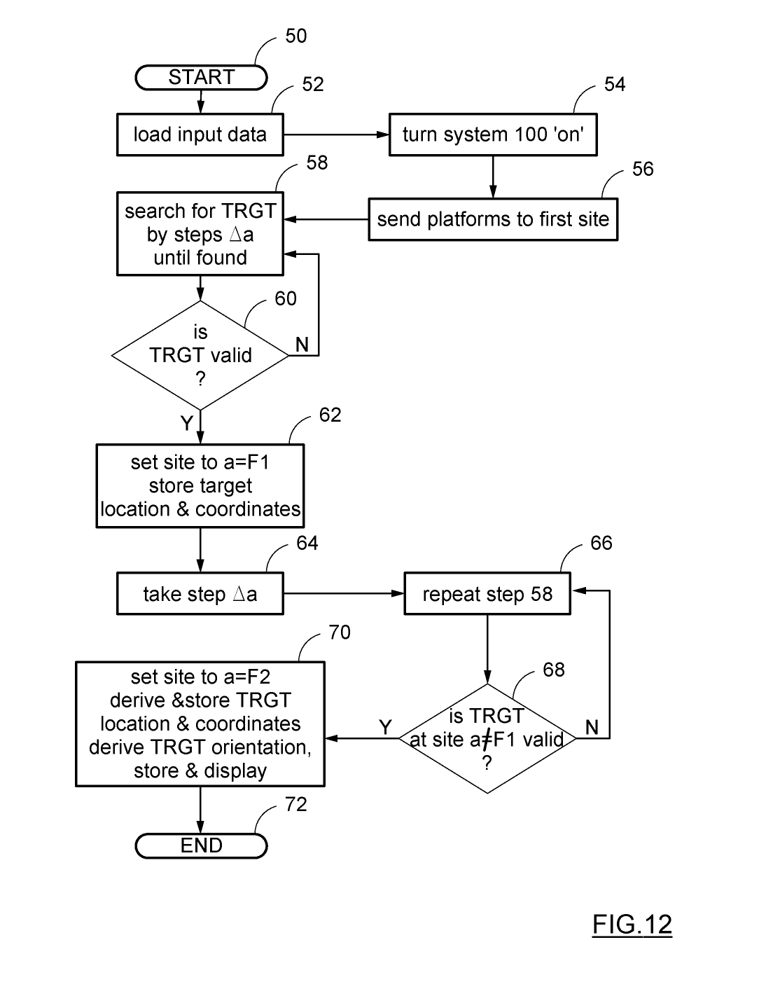

With a system 100, receiver antennas RA may be supported by one or more mobile and/or guided land borne platform PLTF as described hereinabove. A system 100 may include a mobile guided vehicle which carries a transmitter antenna TA, and a mobile guided vehicle which carries at least one receiver antenna RA. A set of mobile platforms PLTF that support at least one receiver antenna RA may include one master platform and one or more thereto slaved platforms. Instead, as shown in FIG. 13, a land borne mobile platform PLTF that carries a radar transmitter TX and a transmitter antenna TA may carry a foldable and/or an extensible structure Xx that may extend above and/or beyond the footprint of the platform PLTF and may deploy and rotate a receiver antenna RA along a closed course CRS. Alternatively, it is possible to appropriately dispose three or more receiver antennas RA in proper mutually separated apart location relative to each other on the extensible structure 22. The at least one receiver antenna RA may be disposed on or above the guided platform PLTF, and may pivot about a vertical pylon 24, or an inclinable support axis 24, and rotate thereabout to cover, for example, a closed course CRS.

Mobile platforms PLTF may be manually or automatically commanded and controlled by the centralized system control and data processing unit SCDP, or by decentralized units) or by standalone unit(s), although these last two are not shown as such in FIG. 6. For those skilled in the art, the monitoring and the controlled disposition in selected location, attitude, and orientation of mobile platforms PLTF in time and in space is well known, and further elaboration thereabout is superfluous.

The block diagram of the system 100 shown in FIG. 6 depicts a centralized system control and data processing unit SCDP. However, neither the system control nor the data processing unit need necessarily to be centralized. The control, command and monitoring of platforms PLTF supporting the emitter antenna TA and/or supporting the receiver antenna(s) RA, as well as facilities reporting the position of the emitter antenna TA and/or of the receiver antenna RA, may be distributed, or may be incorporated in other elements or units of the system 100. Likewise, data processing may be distributed and may include hybrid and/or standalone units, or may be incorporated into other elements of the system 100 for operation in mutual association.

In FIG. 6, the operation station OS is coupled to the system control and data processing unit SCDP, which allows an operator, not shown in the Figs., to operate, command and control the system 100. The system control and data processing unit SCDP may include the computer hardware and software programs necessary to derive the azimuth of the target TRGT, the target spatial location coordinates, and target orientation data, to deploy, dispose, monitor, and locate the receiver antenna(s) RA, and the emitter antenna TA.

Still in FIG. 6, the system control and data processing unit SCDP may command and control the disposition in time and location of the receiver antenna(s) RA, and may receive location and time feedback information via the receiver antenna location communication channel RACC. The receiver antenna channel RACC is marked as a double headed dashed arrow which couples the receiver antenna RA with the system control and data processing unit SCDP. Such a disposition, command, and control capability is useful when the receiver antenna(s) RA is/are mounted on unmanned and/or remote controlled land borne or airborne platform(s) PLTF. The same antenna channel RACC may independently correlate the time and the site ‘a’ of operation with the collected signals.

### Signals Identification

To identify the location of a receiver antenna RA, one may append to the reference indication thereof, i.e. RA, a suffix ‘j”, such as RAj, where” ‘j” may be selected as a positive integer. A first predetermined location of the receiver antenna may for example be indicated as RA1, for j=1, and such further locations as RA2, RA3, etc. Evidently, to derive enhanced and reliable results, the receiver antenna(s) RA may be ‘read’ or sampled in successive loops, i.e. occurrences or passes, hence sampled more than once. Therefore, a second suffix may be useful to identify the number of the sampling of the receiver antenna(s) RA, such as “j” for the location of the receiver antenna RA and “k” for the specific number of the sampling. Both suffixes may be selected as positive integers. For example, RA24 may mean that the receiver antenna RA is disposed at the known location “j”, or here 2, and was sampled at occurrence “k”, which here is the fourth sampling. More suffixes may be added, such as for example a suffix indicating time or related to or referring to time.

To derive not only the location on a target TRGT such as an underground tunnel for example, but also the orientation thereof, one has to transfer the stationary transmitter antenna TA from one site ‘a’ to another site. Thereafter, the target relocation procedure is repeated and use is made of at least two such location coordinates to derive the orientation of the target TRGT. Hence, the emitter antenna TA may be disposed at a known location at a first site ‘a’, where a=1 for example. Next, the emitter antenna may be relocated relative to the first site ‘a’ to a known location of a second site ‘a’, this time, say at a=2. The index ‘a’ may be selected as a positive integer prefix. Hence, the addition of the prefix ‘a’ to TA as ‘aTA’, identifies the known location at the known site at which the emitter antenna TA is disposed.

The same prefix ‘a’ is also used with the receiver antennas RA, i.e. aRA, with the radar transmitter TX, i.e. aTX, with the time values ‘t’ shown in FIGS. 2-4, and for the hyperbolas H depicted in FIG. 5, i.e. aH.

FIG. 6 thus shows an emitter antenna aTA, which is disposed at a known site ‘a’ that emits signals ‘at1’ towards the receiver antennas aRA. A second suffix may be added to identify number of the loop, or pass, if more than one, at which a signal was collected, such as aRAjk. For example, 7RA24 means that at site 7, the receiver antenna RA disposed at the known location j, or here 2, was read at loop or occurrence k, which here is the fourth loop.

As illustrated in FIG. 6, the emitting antenna at site ‘a’, aTA, emits signals ‘t1’, relative to time t0, towards the receiver antennas aRAjk, say to three antenna dispositions 1, 2, and 3 for j=3, at a reading pass k. These emitted signals ‘t1’ reach the receiver antennas aRAjk at time at1jk meaning that at site “a’, the emitted signal ‘t1’ was received by antenna j at the repetition number k.

Simultaneously with the emitted signals ‘at1’ directed towards the receiver antennas aRA, the emitter antenna aTA emits signals ‘at2’ that are directed towards the target TRGT, and these emitted signals are indicated as at2jk. Likewise, signals reflected from the target TRGT towards the receiver antennas aRAjk are designated as at3jk.

The emitted signals at1jk and at2jk and the reflected signals at3jk are forwarded by the receiver antennas aRAjk to the system control and data processing unit SCDP which holds in memory, amongst others, the location of the emitter antenna aTA and of the receiver antennas aRAj, or aRAjk. Information collected from three receiver antennas disposed at aRAjk for the same ‘a’ and ‘k’ with three different suffixes ‘j’ are sufficient for the system control and data processing unit SCDP to compute the coordinates, for example the x, y, and z Cartesian coordinates, or polar coordinates, of the location of the underground target TRGT. The same information taken from two different sites ‘a’, thus each one with a different prefix ‘a’, permits to compute the orientation of the underground target TRGT.

Collected signals are time stamped and stored in memory for time correlated processing.

### Speed of Propagation of Signals Underground

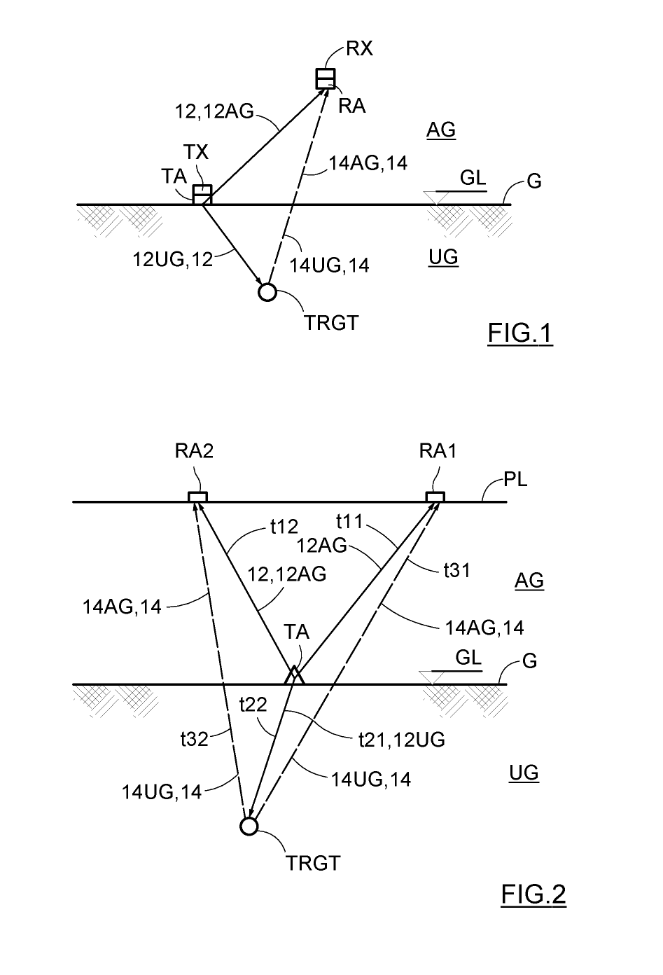

In FIG. 1 for example, the emitter antenna TA, which is disposed in relation with the ground G, emits signals 12UG that travel through the underground UG to the target TRGT, while signals 12AG propagate through the air to the receiver antenna RA. In addition, the receiver antenna RA also collects signals 14 echoed from the target TRGT, having a portion 14UG that propagates in the underground UG and a portion 14AG that travels in the air. The speed of electromagnetic signals in the air is about the speed of light, which is well known, but the speed of propagation of an electromagnetic wave EW in the underground UG may not be known.

Echoed signals 14 collected from the target TRGT by a receiver antenna RA are delayed signal relative to the time of reception of a respective emitted signal 12AG. Underground delayed signals pose at least two difficulties. First, underground signals 12UG and 14UG propagate at an unknown speed until they reach the ground level GL and break into the air. Second, the passage from an anisotropic medium such as the underground UG, to the air, which is practically an isotropic medium, will cause refraction at the interface separating both media. Therefore, reflected signals 14 will not pass from the underground target TRGT to the receiver antennas RA in the air, in a straight line direction.

Furthermore, the electric properties of the echoed signals 14 may be affected by various effects such as scattering, fading, and noise, which effects may be alleviated by help of dedicated computer programs and by the appropriate polarization of the emitted signals.

Methods for the derivation of the speed of propagation of electromagnetic signals or of electromagnetic wave fronts in the underground UG are now considered.

The speed of propagation of electromagnetic signals at a site ‘a’ in the underground UG below the transmitter antenna TA may either be known a priori, or be measured in laboratory from samplings taken from the underground soil S. Alternatively, a reference target TRGT may be disposed underground at various known depths, at a known distance from the transmitter antenna TA and from the one or more receiver antennas RA, and at a plurality of zones of ground G, or sites ‘a’. The same may be repeated for various volumes of soil S. The system 100 may thus be operated to derive the unknown speed of propagation of electromagnetic signals in an underground soil S in accordance with the prerequisite conditions related to the transmitter antenna TA, to the receiver antenna(s) RA, the known ranges to the target TRGT, and in correlation with time. Such prerequisite conditions include the knowledge of the spatial coordinates of the location of the transmitter antenna TA and of the receiver antenna(s) RA in time correlation with the emitted signals and the collected signals.

The requested speed in the underground UG may further be obtained from the rate of change of the range, i.e. dRANGE/dx, as measured from the target TRGT to a receiver antenna RA that is disposed at various known locations. The range is the distance that separates the target TRGT from the receiver antenna TA. However, the rate of change of the range depends mainly on the length of the path travelled underground by the radar signal, and has to take in consideration the angle of refraction that deviates those signals away from propagation along a straight line.

The following equation 1 provides a quantitative value indicative of the speed of propagation of signals in the underground UG:

Gzone=(Maximum Delay−Minimum Delay)/Average Delay (equ. 1)

Equation 1 is based on the assumption that the average speed of the electromagnetic wave in the vicinity of the target TRGT does not vary with the change of direction towards the receiver antenna RA.

Measurements taken by a system 100 for a predetermined configuration of target(s) permit to derive results from equation 1. The time of travel of signals reflected from underground targets TRGT buried at unknown locations, to various known locations of a receiver antenna RA translating on a given closed course CRS disposed in association with the transmitting antenna TA, may be measured in nanoseconds for example. A plot along an axis X of the derived results, for one loop of the receiver antenna RA, will look as a sinus-like wave proportionate to the maximum range and to the minimum range referred to in equation 1. The sinusoid may start at a minimum value, grow to a maximum, and then diminish to drop back to the minimum. Based on the known configuration of the system 100 and on the location of the target(s) TRGTs, it is possible to set up reference tables from which the speed of propagation of underground signals in different zones of soil S may be derived.

### System Implementation

FIG. 7 shows an exemplary block diagram which illustrates the main elements of the radar transmitter TX and of the radar receiver RX, shown respectively in frames 30 and 40.

In FIG. 7, the radar transmitter TX is delimited by a frame 30 of dashed lines. The radar transmitter TX may include a coherent frequency synthesizer and synchronizer 32, a modulator 34, a power amplifier 36, and the transmitter antenna TA. If distributed processing is desired, the radar transmitter TX may include a signal processor and control capability, although not shown in FIG. 7, such as for processing radar signals and for the output of target data for example. Else, processing functions may be provided by the system control and data processing unit SCDP.

The radar transmitter TX is coupled in bidirectional communication with the system control and data processing unit SCDP via the frequency synthesizer and synchronizer 32, which generates the emitted signals 12 shown in FIG. 1, as well as time signals for the thereto coupled modulator 34. These timing signals are also forwarded to the system control and data processing unit SCDP for the generation of internal memory space wherein collected data and output results may be stored and processed in correlation with the time signals.

The modulator 34 is coupled, via the power amplifier 36 to the transmitter antenna TA, which transmits above ground emitted signals 12AG to the receiver antenna RA, and transmits underground emitted signals 12UG to the target TRGT.

The radar emitter TX may use frequency synthesizer and synchronization circuits 32 for the carrier wave. Signal synchronization is derived from the frequency of the carrier wave such that the emission pulse will start in phase with the carrier wave to obtain optimal coherent integration.

The emission frequency may be selected to be as low as possible, say of the order of magnitude of tenths of Megahertz, or less, in consideration of the reduction of the attenuation in the ground G versus the structure of the emitter antenna(s) TA and the availability of wideband power amplifiers.

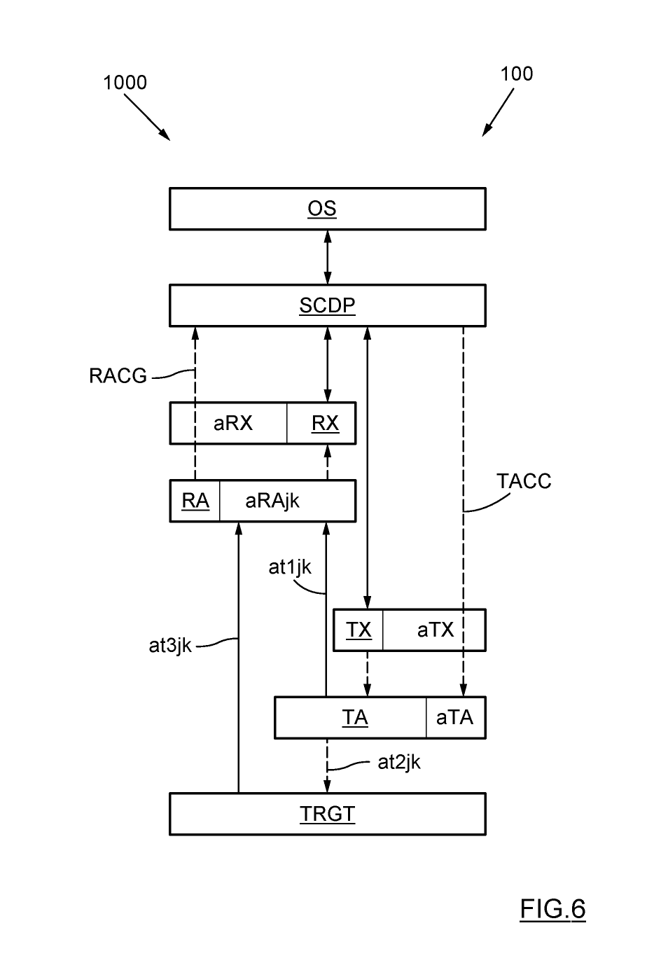

Preferably, video pulse emission signals are used in a succession of one positive pulse and one negative pulse elements, as shown in FIG. 8. Such video pulse emissions may have a spectrum that remains free of DC current and the frequency carrier wave will be FCarrier=PRF/2, (Pulse Repetition Frequency).

During the first target TRGT detection search steps use may be made of pulses of say 100 nanoseconds to avoid loss of energy and also to obtain a much stronger echo signal from the target TRGT in view of the increase in radar cross-section of the target. Subsequent more accurate target location steps may revert to narrower pulses. A pulse of some 50 nanoseconds may have a broad spectrum since a large portion of the energy contained in the higher frequencies will be absorbed by the soil S.

The rate of emission of pulses is dependent of the expected maximum range Rmax and the addition of a certain safety factor to prevent the arrival of one string of echo signals after the arrival of the next string of emissions, and may therefore be selected to have a period of about 15 microseconds. The momentary power of a pulse may reach between 100 and 1000 Watts.

The radar receiver RX, delimited in FIG. 7 by a frame 40 of dashed and dotted lines, may include the receiver antenna RA, which is coupled to and which transmits collected signals to the system control and data processing unit SCDP, via a low noise amplifier 42. Preferably, the radar receiver RX may also include a F1-F2 repeater 44 which receives input from the low noise amplifier 42. The repeater 44 may transmit the collected signals to the system control and data processing unit SCDP to which it is coupled by wired or wireless communication. If a F1-F2 repeater 44 is provided, this last one accepts signals from the low noise amplifier 42 for transmission via wireless communication to the data processing unit SCDP. Alternatively, the F1-F2 repeater 44 may be replaced by other communication media, e.g. a fiber optic line that may be coupled to the system control and data processing unit SCDP.

The radar receiver RX may include a receiver antenna RA, a location control unit 46 which may be coupled in bidirectional communication to the system control and data processing unit SCDP or for example to another dedicated control unit having a capability of tracking and/or of monitoring and reporting the location of the one or more receiver antenna(s) RA. As shown in FIG. 1, a receiver antenna RA collects the emitted signals 12AG from the transmitter antenna TA and the echoed signals 14 from the target TRGT, as well as noise. In a first step, the radar signals 12 and 14 are forwarded to and are amplified by the low noise amplifier 42 if available. From the low noise amplifier 42, in a second step, the radar signals 12 and 14 are transmitted to the system control and data processing unit SCDP which may derive data from the collected echoed signals, say by use of leading edge detection. The system control and data processing unit SCDP may store in memory the delay of time Δt that starts from the time of transmission of an emitted signal 12 and ends with the time of reception of a thereto related echoed signal 14 in time correlation with the momentary spatial location of the receiver antenna(s) RA and the location of the transmitter antenna TA.

Since the radar emissions are low frequency signals, the transmitter antenna TA may be relatively large, say of about a few meters. The transmitter antenna TA may be selected for example as a horizontal antenna for disposition above the ground G but close thereto, on the ground, or in the topsoil. Furthermore, a reflector may be disposed on top of the horizontal transmitter antenna TA to concentrate and direct the emitted signals 12UG into the underground UG, to prevent loss of energy to the air. Use may also be made of a whip antenna, a dipole antenna, or of a conic antenna. Horizontal polarization may have advantages over vertical polarization with respect to echoed signals returned from the ground G.

### Operation of the System

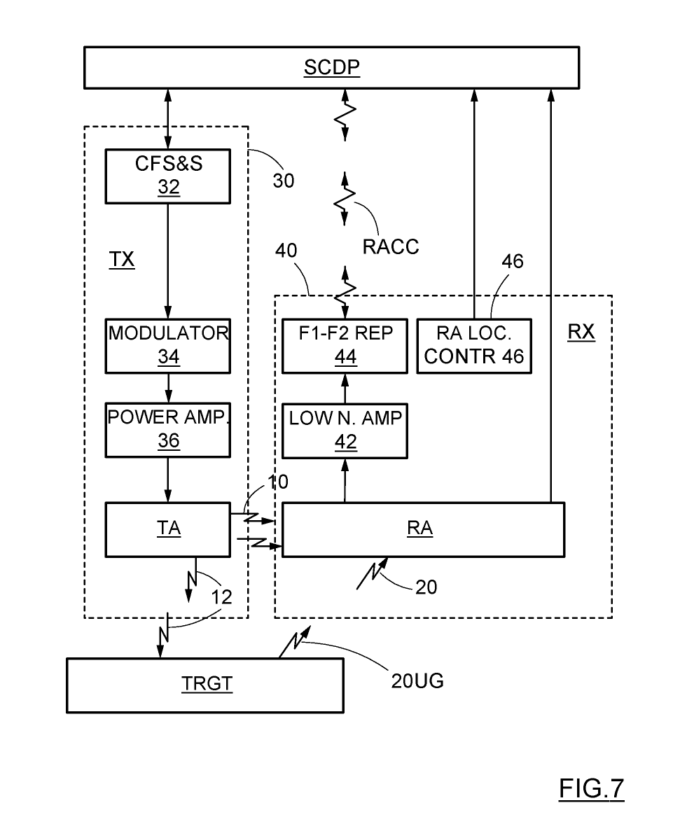

FIG. 9 schematically depicts a cross section taken perpendicular the ground G and through of the transmitter antenna TA. The transmitter antenna TA may be disposed in the topsoil S, on the ground G, or above the ground at a transmitter antenna height HTA of up to 10 m for example. Assuming that the soil S is homogeneous, radar signals emitted by the transmitter antenna TA penetrate into the ground G according to the maximum range of the radar, and form therein a maximum hemisphere Hmax having a maximum radius Rmax and a maximum volume Vmax. However, as well known with radars, the emitted radar signals become effective beyond a minimum hemisphere Hmin, of minimum volume Vmin having a maximal radius Rmin. The radar signals may thus scan an effective volume or examined volume of ground EV that is limited to the volume of ground cell VG that is disposed between the maximum hemisphere Hmax and the minimum hemisphere Hmin. It is noted that a site ‘a’ is defined as the circle on the ground G having a maximum radius Rmax. In other words, a site is the surface of ground G wherein the transmitter antenna TA is at the center of a circle ‘a’ having a periphery which has a maximum radius Rmax.

The receiver antenna RA, shown in FIG. 9, may be disposed relative to the ground G, on the ground or at a receiver antenna height HRA which is disposed in a plane PLRA parallel to the plane of the ground level GL. The receiver antenna RA may be one of a plurality of such antennas that translate in range for operative association with the transmitter antenna TA, for example along a circular or an elliptical course CRS or along another closed geometric course CRS. As mentioned hereinabove, the coordinates of the locations of the transmitter antenna TA and of the momentary location of the one or more receiver antenna(s) RA are known.

FIG. 10 schematically depicts an exemplary embodiment of the method and of the system 100 which operates a set of platforms PLTF on a volume of ground VG at a site ‘a’. There is shown a land borne transmitter antenna TA that is coupled in operative association with an airborne receiver antenna RA which translates along a closed course CRS. However, the system 100 may operate with various types of platforms PLTF and in various sets of platform configurations, even though not being shown as such in FIG. 10.

Platforms PLTF may be selected as the same or as a combination out of different kinds of vehicles, differently controlled, and operating in various configurations. As a vehicle, a platform PLTF may be stationary or mobile, land borne or airborne and have specific means of propulsion. Control of a platform PLTF may be selected as desired, from manual control to various stages of computerized control and up to autonomous control. Regarding operative configuration, a stationary implementation is possible, as described hereinabove. Alternatively, one may consider one or more than one type of vehicle and mode of control.

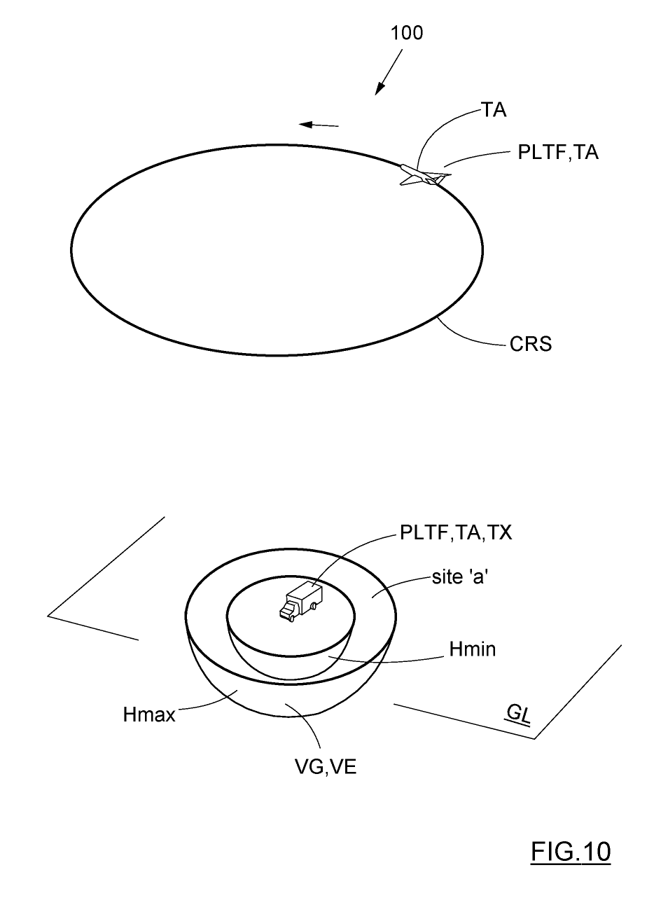

FIG. 11 is a schematic illustration of the time delays Δt that may be derived along a loop of a mobile receiver antenna RA that translates on a closed course CRS when disposed in range for operative association with a transmitter antenna TA and a target TRGT. The transmitter antenna TA is disposed at a site ‘a’, and transmits signals that form the effective volume EV as delimited by the maximum hemisphere Hmax and the minimum hemisphere Hmin. Thereby, the transmitter antenna TA is located at the center of the site “a’. The target TRGT is shown to cross the examined volume EV.

The receiver antenna RA may be supported on a platform PLTF, airborne or land borne which translates along a closed course CRS path or orbit disposed in range for operative association with the transmitter antenna TA. The closed course CRS has a known predetermined shape, is well monitored and controlled and may translate the platform(s) PLTF either at a height HRA disposed above and in a plane parallel to the ground G, or on the ground G.

A signal above ground 12AG, emitted by the transmitter antenna TA which may be disposed at a height HTA above ground G, may penetrate into the ground G of the examined volume EV as a sharply refracted underground signal 12UG and hit the target TRGT. An underground echoed signals 14UG returns from the target TRGT towards the receiver antenna RA, and exits out of the underground UG as a sharply refracted echoed signal 14AG which is collected by the receiver antenna RA. The time delay Δt that lapses between the time of emission of a signal by the transmitter antenna TA and the time of collection of the relative thereto echoed signal 14AG is depicted as a vertical double headed arrow marked Δt. Such a time delay Δt is symbolically depicted to stretch up from the periphery of the closed course CRS, has a length proportional to the duration of the time delay Δt, and may be saved in memory in correlation with the time and the instantaneous location of the receiver antenna RA. For example, the memory may be a memory device M coupled to a data processor DP, both last not shown, pertaining to the system control and data processing unit SCDP.

It is evidently also the instantaneous location of the receiver antenna RA relative to the target TRGT and to the transmitter antenna TA that may define the length in time of the time delays Δt. Therefore, an analysis of the characteristics of the collected time delays Δt may provide indications such as for example azimuth, depth and range, which indications are related to the location of the target TRGT. It is the system control and data processing unit SCDP that may compute the time delays Δt on the basis of the following necessary information: the correlation with time of the coordinates of the location of the transmitter antenna TA, and the coordinates of the instantaneous location of the receiver RA. This means that the coordinates of the instantaneous location of the receiver RA have to be provided to the system control and data processing unit SCDP in real time.

Even intuitively it is accepted that the farther away a receiver antenna RA is distanced away from a target TRGT, the longer lasts the interval, or time delay Δt. In the opposite, the closer by a receiver antenna RA is to a target TRGT, the shorter the time delay Δt. A maximum time delay Δtmax is usually disposed opposite at 180° to a minimum time delay Δtmin. A maximum time delay Δtmax and a minimum time delay Δtmin may be selected on the closed course CRS. A vector that ranges from the maximum time delay Δtmax to the minimum time delay Δtmin thus points in the direction of the target TRGT and is an azimuth thereto.

In the particular case when the closed course CRS is a circle and the transmitter antenna TA is disposed just above the target TRGT, then the range from the transmitter antenna to the target TRGT is practically the same for any location of the receiver antenna RA along the closed course. Hence, the derived time delays Δt will be about the same over the closed course CRS. The absence of a maximum time delay Δtmax and a minimum time delay Δtmin will prevent to derive an azimuth towards the target TRGT. Therefore, an elliptic closed course CRS is preferred over a circular closed course for the reason that is possible to discern the effect of the change of range, which is reflected by the time delays Δt, even for a target TRGT that is disposed exactly below the transmitter antenna TA.

The closed course CRS of the receiver antenna RA may not necessarily be symmetric or centered relative to the transmitter antenna TA. However, a condition for the selection of the course CRS is that, as described hereinabove, a target TRGT that crosses the effective volume EV is detected along the entire closed course CRS. Furthermore, a significant difference in range and in angle to the target TRGT has to be detected over the length of the entire course CRS. Such a significant difference is regarded as a difference that is a detectable relative to the range resolution of the system 100 so that it will be possible to find a maximum time delay Δtmax and a minimum time delay Δtmin that will clearly indicate an azimuth of the target TRGT.

### Steps of Operation

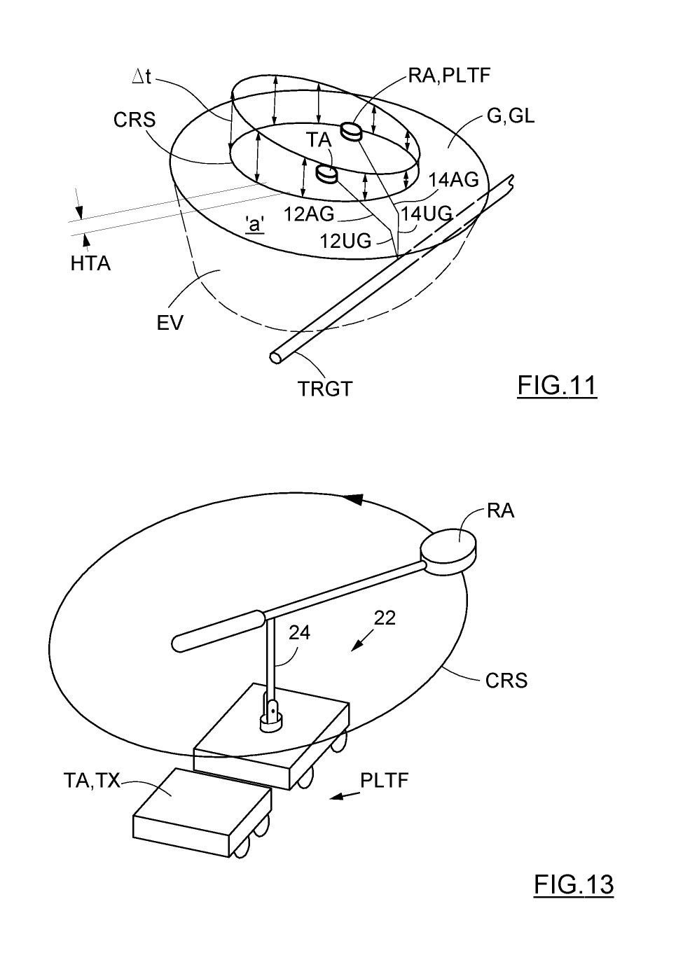

FIG. 12 shows a flowchart for the sake of illustration of a simplified example of the operation of the system 100. One may consider patrolling a border in search for a target TRGT structure, say of an underground tunnel for the illegal crossing a frontier. The system 100 may be operated to automatically search along the border, detect, and output a location and orientation of such a border crossing tunnel.

The various stages of operation of the system 100 start with step 50.

At step 52, input data which may include information and computer programs saved a priori, is loaded into the system 100. Such input data may include the location or site ‘a’ for the start of the search operations, the selection of the closed course CRS and the speed of the platform(s) PLTF along the closed course CRS as well as a route along which the search, detection, location and orientation determination process of the target TRGT will be carried out. The distances of displacement Δa from one site ‘a’ to a next site along the route, and the number of loops ‘m’ to be travelled at each site ‘a’ by the receiver antenna(s) RA that are supported by platform(s) PLTF, may are read as input data. Alternatively, such input data may be derived from collected radar signals and be used during the operation of the system 100. It is assumed that the speed of propagation of underground signals is known and stored in memory for the different sites ‘a’ at various depths under the ground level GL along the route of search.

In step 52, input data may thus be loaded into a data processor μP and saved into a memory M that is coupled to the processor μP which is configured to read data from the memory and to execute computer programs stored therein. Such a data processor may be included, for example, in the centralized system control and data processing unit SCDP, shown in FIG. 7, or as a decentralized or hybrid data processor array included in the system 100. The data processor μP and the memory M are not shown in the Figs.

Next, in step 54, the system 100 is turned ‘ON’ to the operative state for the various elements of hardware and software computer programs of the system to become operational. Such elements may include the platforms PLTF that support the antenna TA, and the receiver antenna(s) RA. It is noted that the wording “platform PLTF” may refer to either a single or a plurality of platforms.

Thereafter, in step 56, the platform(s) PLTF translate to a designated initial search site indicated for example as site a=a0.

At the initial site a=a0, the transmitter antenna TA of the radar transmitter TX emits signals and the receiver antenna(s) RA collect(s) the radar signals RS as emitted and the echoed signals. These radar signals RS are sampled and their amplitudes and times of arrival or time delays Δt, are stored in the memory M of the data processor μP.

At step 58, the platforms PLTF search for a target TRGT, and if not found, move along the route to a next site ‘a’, through incremental steps Δa until the target is found. An incremental step Δa may preferably be selected as a distance of travel that will provide an overlap of the effective volumes or examined volumes EV of adjacent sites ‘a’.

Step 58 may be divided into two stages, namely with a first search stage using wider pulses for the easier detection of smaller or remote targets TRGT, and a second localization step using narrower pulses with a better range resolution for the derivation of the three dimensional geometric coordinates that accurately locate a detected target. In step 58, the platform PLTF carrying the receiver antenna(s) RA makes at least one signal collection loop ‘m’ over a predetermined closed course CRS while being disposed in range for operative association with the transmitter antenna TA, to collect data from at least three mutually separated apart different locations along the loop ‘m’. Evidently, the receiver antenna(s) RA may make more than one loop to of search of the examined volume EV at the center of which the transmitter antenna TA is disposed.

When a target TRGT is found, the collected radar signals are processed, analyzed, and validated at step 60.

Step 60 checks if the collected signals are valid, meaning for example, that they exceed at least one predetermined threshold and that there is a high level of probability that it is actually a target TRGT that has been detected. Next, the collected signals and their relative correlated timing are processed. Target location is derived and may be checked again for validity.

Should the target TRGT not have been found, then step 58 is repeated: the platforms PLTF travel to still another site ‘a’, say each time by a preset distance step Δa away from the previous site ‘a’. Repetition of the step 58 continues until a target TRGT is found and validated by step 60 as a first location of the target TRGT. When a target TRGT is detected, control passes to step 60 and from there to step 62.

Control then passes to step 62 were the three dimensional geometric coordinates of the first derived location of the target TRGT are saved in memory and the site ‘a’ at which a first location of the target was found is designated as for example, a=F1. If desired, data regarding the first location may be displayed. Process now flows to step 64.

In step 64, the support platforms PLTF travel to a next site ‘a’ through a preset travel distance of at least one step Δa away from the first site F1 which was recorded at step 62.

Next, in step 66, step 58 is repeated. The aim of the repetition of step 58 is to find the location of a second portion of the target TRGT, to acquire one more but different set of target coordinates for the purpose of deriving the longitudinal orientation of the target. If another portion of the target TRGT is not found, then the search continues through at least one more step Δa, until the target TRGT is found and control flows to step 68.

Step 68 checks if the returned signals are valid, meaning for example, that they exceed at least one predetermined threshold and that there is a high level of probability that it is actually a second portion of the target TRGT that has been detected at a second site, which site a=F2 is different from the first site where a=F1. The collected signals and their relative correlated timing are processed. Target location is derived and may be checked again for validity. When the target location is validated, control passes to step 70.

At step 70, the three dimensional coordinates of the second derived location of the target TRGT are saved in memory and the site ‘a’ at which a second location of the target TRGT was found, is designated as a=F2. If desired, data regarding the second location may be displayed. Next, the orientation of the target TRGT is computed on the basis of the first and of the second valid located portions of the target TRGT. Data regarding the location of the two derived sites a=F1 and a=F2, as well as the orientation of the target TRGT may be displayed. Evidently, more valid portions of the TRGT may be derived and stored in memory M to enhance accuracy of location and orientation.

In the present example, process now flows to step 72, which ends the procedure.

The embodiments disclosed herein are to be considered in all respects as illustrative, and not restrictive of the invention. The embodiments described hereinabove do no limit the present invention in any way. Various modifications and changes may be made to the embodiments without departing from the spirit and scope of the invention. The scope of the invention is indicated by the attached claims, rather than the embodiments. Various modifications and changes that come within the meaning and range of equivalency of the claims are intended to be within the scope of the invention.

### INDUSTRIAL APPLICABILITY

The system which is based on the method described hereinabove, is suitable for production in industry.

### REFERENCE SIGNS LIST

| Ref | Description |
|---|---|
| Δ | time difference in time or in location |
| Δa | difference in site location |
| Δt | time delay |
| μP | processor |
| ABRN | airborne platform/vehicle |
| AG | above ground |
| CRS | Circular Course |
| EM | electromagnetic |
| EV | examined volume |
| G | ground |
| GL | ground level |
| H | hyperbola |
| Hmax | maximum hemisphere |
| Hmin | minimum hemisphere |
| HRA | receiver antenna height |
| HTA | transmitter antenna height |
| LBRN | land borne platform/vehicle |
| m | number of loop over a closed course |
| | CLCR |
| M | memory |
| OS | operation station |
| PLRA | plane parallel to the plane of the |
| | ground level GL |
| RA | receiver antenna |
| RACC | receiver communication channel |
| RAPL | receiver antenna platform |
| Rmax | maximum radius |
| Rmin | minimum radius |
| RS | radar signal |
| RX | radar receiver |
| S | soil |
| SCDP | system control and data processing |
| | unit |
| SUPL | supporting platforms |
| TA | transmitter antenna |
| TACC | transmitter communication channel |
| TRGT | target |
| TX | radar transmitter |
| UG | underground |
| VG | effective volume of ground |
| Vmax | maximum volume |
| Vmin | minimum volume |
| 12AG | above ground emitted signal |
| 12UG | underground emitted signals |
| 14 | reflected signal |
| 14UG | underground portion 14UG of the |
| | reflected signal 14 |
| 14AG | above ground portion 14AG of the |
| | reflected signal 14 |
| 22 | structure |
| 24 | vertical pylon or inclinable support |
| | axis |
| 30 | drone |
| 100 | system |
| 1000 | embodiment |

1. A method for locating a target disposed below ground by using radar signals, including emitted signals generated by a radar transmitter coupled to at least one transmitter antenna and echoed signals collected from the target by a radar receiver coupled to the at least one transmitter antenna,
the method comprising:
operating a range only radar transmitting emitted signals via the transmitter antenna disposed at a predetermined location relative to the ground,
collecting the radar signals via the at least one receiver antenna translating above ground along a controlled closed course selected for operating in cooperation with the transmitter antenna, and
processing the radar signals in correlation with time and with a respective momentary location of the at least one receiver antenna and the location of the transmitter antenna.

2. The method of claim 1, wherein relative to the ground, the transmitter antenna is disposed in one of top soil of the ground, in contact with the ground, and up to 10 meters above the ground.

3. The method of claim 1, wherein emitted signals are collected along at least one of 50%, 75%, and 90% of the controlled closed course.

4. The method of claim 1, wherein the emitted signals are selected as video pulse strings having a succession of one positive pulse and one negative pulse.

5. The method of claim 1, wherein the emitted signals have an emission frequency ranging from 10 Megahertz to 100 Megahertz.

6. The method of claim 1, wherein:
intervals separating apart between a time of transmission of an emitted signal and a time of reception of a respective echoed signal are collected over the closed course as time delays from which a maximum time delay and a minimum time delay are derived,
each time delay is correlated with a momentary location of the at least one receiver antenna at time of collecting signals, and
a vector ranging from a location of the maximum time delay to a location of the minimum time delay points in a direction of the target.

7. The method of claim 1, wherein the transmitter antenna is disposed on a land borne platform and the at least one receiver antenna is disposed on the same land borne platform or on a platform selected as at least one of another land borne platform and an airborne platform.

8. The method of claim 7, wherein the land borne platform(s) and the airborne platform are selected as at least one of a mobile platform, a driver guided platform, a remotely guided platform, and an autonomously guided platform.

9. The method of claim 1, wherein the transmitter antenna is selected as one of a dipole antenna, a conic antenna, and a whip antenna.

10. The method of claim 1, wherein the shape of the closed course is selected as one of a circle, an ellipse, a symmetric shape, and an asymmetric shape.

11. A method for scanning an initial site of ground for detecting and for locating a target buried underground,
the method comprising:
providing a range only radar using a radar transmitter coupled to a transmitter antenna, and at least one receiver antenna coupled to a radar receiver,
a) disposing the transmitter antenna at a known location relative to the ground, and emitting radar signals generated by the range only radar transmitter,
b) operating at least one range only receiver antenna translating on a closed course and operating in association with the transmitter antenna for collecting emitted range only radar signals and signals echoed from a target and received from a plurality of separated apart known locations of the at least one receiver antenna,
c) processing collected signals for detecting a target, wherein:
i. when the target is not detected, relocating the transmitter antenna and the at least one receiver antenna to a next site and repeating steps a)-c) until the target is detected, and
ii. when the target is detected, processing the collected signals for deriving a first location of the target and indicating the site as a first site.

12. The method of claim 11, wherein:
steps a)-c) are repeated at a next site distanced away relative to the first site, until the target is detected, and
when the target is detected, processing the collected signals for deriving a second location of the target and indicating the next site as a second site.

13. The method of claim 12, wherein an orientation of the target is derived from the first location and from the second location of the target.

14. A system configured to operate a range only radar to scan sites of ground in search of a location of a target disposed under the ground, wherein the radar has a radar transmitter which is coupled to an emitter antenna that transmits emitted signals to a radar receiver which collects radar signals, including emitted signals and echoed signals returned from the target, via at least one receiver antenna, and wherein the system is commanded and controlled by a system control and data processing unit,
the system comprising:
at least one receiver antenna which is coupled to the radar receiver and is configured to collect radar signals from the emitter antenna that is disposed at a predetermined location relative to—the ground,
wherein the at least one receiver antenna is configured to translate along a closed course in range for operative association with the emitter antenna,
wherein a momentary location of the at least one receiver antenna is monitored, and wherein the momentary locations and the collected radar signals are saved as signals correlated with time, and
wherein the location of the emitter antenna and the time correlated signals are processed by the system control and data processing unit.

15. The system of claim 14, wherein emitted signals and target returned echoed signals collected by the at least one receiver antenna from a plurality of distributed apart locations that are disposed on the closed course are used to derive location coordinates of the target.

16. The system of claim 14, wherein the system control and data processing unit controls a speed of translation and a location of the at least one receiver antenna along the closed course.

17. The system of claim 14, wherein the system control and data processing unit is configured to control a rate of pulses of emitted signals and a speed of translation of the least one receiver antenna for mutual adaption of the rate of pulses and of the speed of translation.

18. The system of claim 14, wherein the system control and data processing unit is configured as a centralized or as a distributed unit operable to control and command the system.

19. The system of claim 14, wherein the system control and data processing unit derives data indicative of an underground speed of propagation of a wave of radar signals from a delay of time that separates apart between a time of transmission from the emitter antenna of one emitted signal, and a time of collection by the at least one receiver antenna of a respective one echoed signal.

20. The system of claim 14, wherein the at least one receiver antenna translates along a closed course relative to and in range for operative association with the emitter antenna and collects radar signals at a predetermined angular separation on the closed course.
